(19) United States
(12) Patent Application Publication
(10) Pub. No.: US 2010/0175634 A1
(43) Pub. Date: Jul. 15, 2010

(54) Pet treadmill

(75) Inventors: Chih-Yin Chang, Nantou County (TW); Sheng-Chao Shih, Nantou County (TW)

Correspondence Address: CHARLES E. BAXLEY, ESQUIRE, 90 JOHN STREET, SUITE 309, NEW YORK, NY, 10038, US

(73) Assignee: Master Maxs Health Technology Inc.

(21) Appl. No.: 12/456,197

(22) Filed: Jun. 11, 2009

(30) Foreign Application Priority Data
Jan. 9, 2009 (TW) 098200312

(51) Int. Cl. A01K 15/02

(52) U.S. Cl. 119/700

(57) ABSTRACT

A pet treadmill includes a power source for outputting a drive power. An exercise platform is laterally connected to the power source. The exercise platform includes a longitudinally main from stably disposed on a supporting ground, multiple supports secured on a bottom of the main frame to make the main frame being separated from the supporting ground, a support platform mounted within the main frame for enhancing the structure of the main frame, two driven axles transversely and rotatably mounted to two opposite ends of the main frame, and an endless strap coiled the two driven axle and surround the support, wherein a corresponding one of the two driven axle is driven by the manual power source to operate the endless strap, on which the pet imitates a jog action.

### BACKGROUND OF THE INVENTION

1. Field of the Invention

The present invention relates to a treadmill, and more particularly to a pet treadmill, on which the pet imitates a jog action.

2. Description of Related Art

In the modern world, more and more people like to feed a pet as a company. However, the feeder usually has not enough time to take an exercise, especially take an exercise with the pet. As a result, some feeder fancifully put his/her pet on a treadmill that is designed for human. It is very dangerous to the pets because the safety of the ordinary treadmill is unsuitable to the pets such that the treadmill can not be stopped in time when the pet is tired or falls down on the treadmill

The present invention has arisen to mitigate and/or obviate the disadvantages of the conventional treadmill that is unsuitable to a pet.

### SUMMARY OF THE INVENTION

The main objective of the present invention is to provide an improved treadmill that is designed for pets.

To achieve the objective, the pet treadmill in accordance with the present invention comprises a power source for outputting a drive power. An exercise platform is laterally connected to the power source. The exercise platform includes a longitudinally main from stably disposed on a supporting ground, multiple supports secured on a bottom of the main frame to make the main frame being separated from the supporting ground, a support platform mounted within the main frame for enhancing the structure of the main frame, two driven axles transversely and rotatably mounted to two opposite ends of the main frame, and an endless strap coiled the two driven axle and surround the support, wherein a corresponding one of the two driven axle is driven by the manual power source to operate the endless strap, on which the pet imitates a jog action.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pet treadmill in accordance with the present invention;

FIG. 2 is a partially exploded perspective view of the pet treadmill in FIG. 1;

FIG. 3 is another partially exploded perspective view of the pet treadmill in FIG. 1;

FIG. 4 is a cross-sectional view of the pet treadmill in FIG. 1 along line A-A;

FIG. 5 is an operational view of the pet treadmill in FIG. 1; and

FIG. 6 is a perspective view of a second embodiment of the pet treadmill in accordance with the present invention.

### DETAILED DESCRIPTION OF THE INVENTION

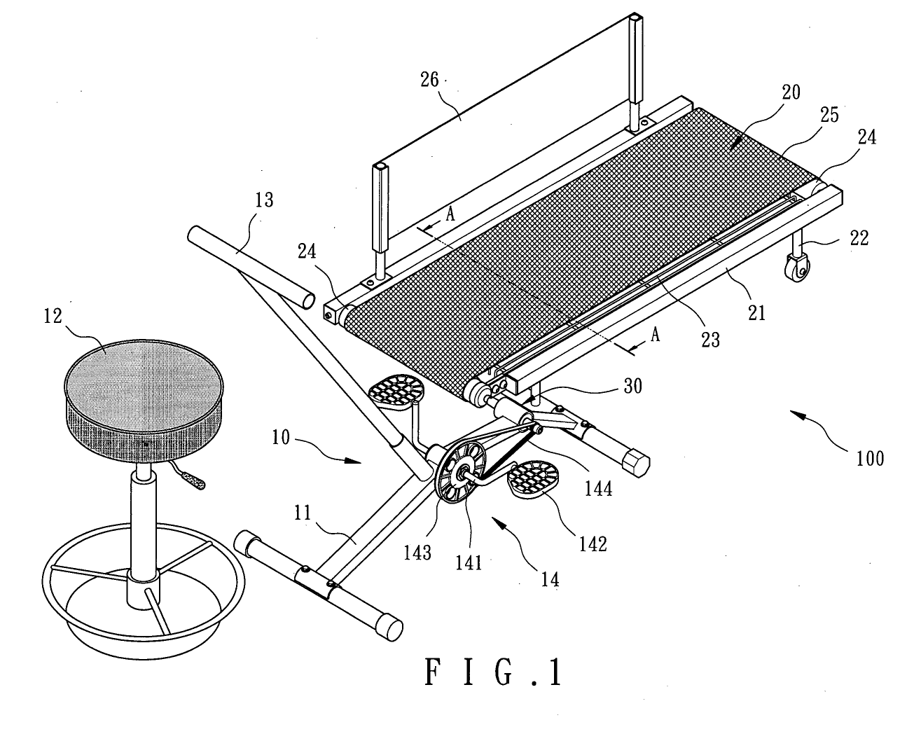

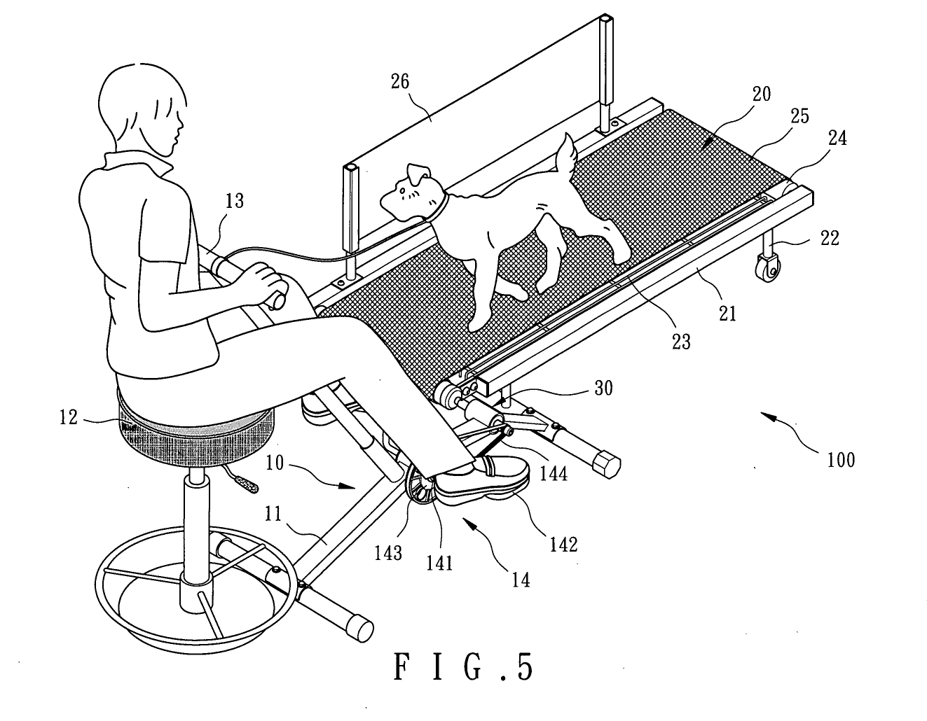

Referring to the drawings and initially to FIGS. 1-5, a pet treadmill (100) in accordance with the present invention comprises a power source (10), an exercise platform (20) laterally connected to the power source (10) and a link device (30) connected to the power source (10) and the exercise platform (20). In the preferred embodiment of the present invention, the power source (10) is operated by manpower.

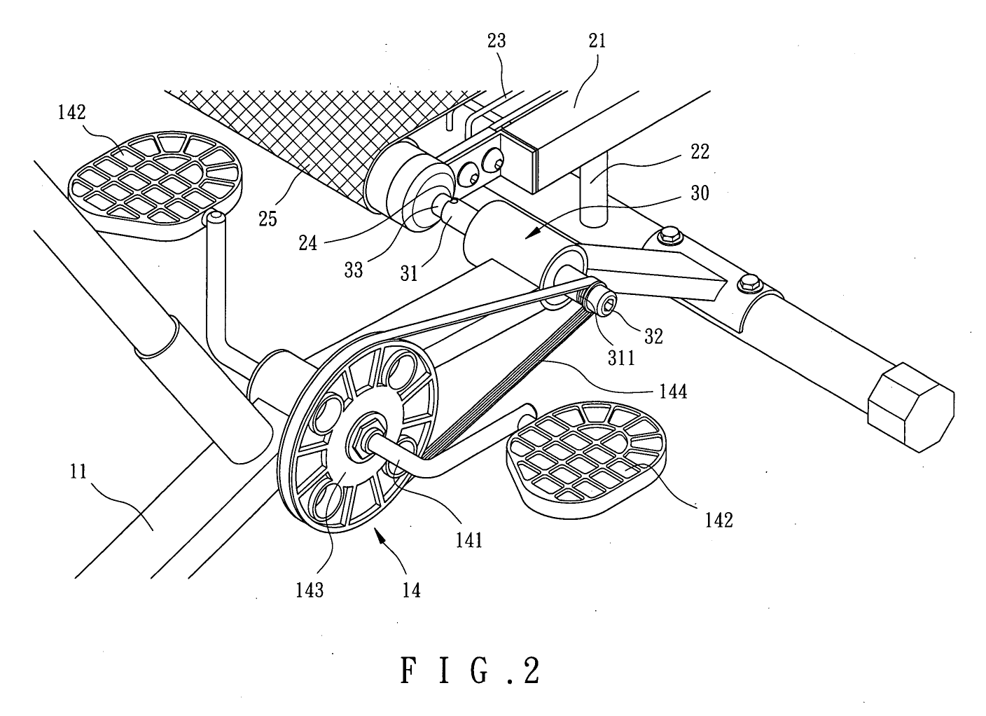

With reference to FIGS. 1 and 2, the power source (10) includes a base (11) and a seat (12) respectively disposed on a supporting ground, wherein the seat is provided for the operator to sit thereon and operating the power source (10). A T-shaped hand bar (13) and a step device (14) respectively mounted on the base (11). The step device (14) includes a crank (141), two pedals (142), a drive wheel (143) and a drive element (144). The crank (141) is mounted on and rotatable relative to the base (11). The two pedals (142) are respectively mounted to two opposite ends of the crank (141) for user to step thereon and driving the crank (141). The drive wheel (143) is securely sleeved on a horizontal portion of the crank (141) such that the drive wheel (143) is synchronously rotated with the crank (141). In the preferred embodiment of the present invention, the drive element (144) is a belt that partially surrounding the drive wheel (143).

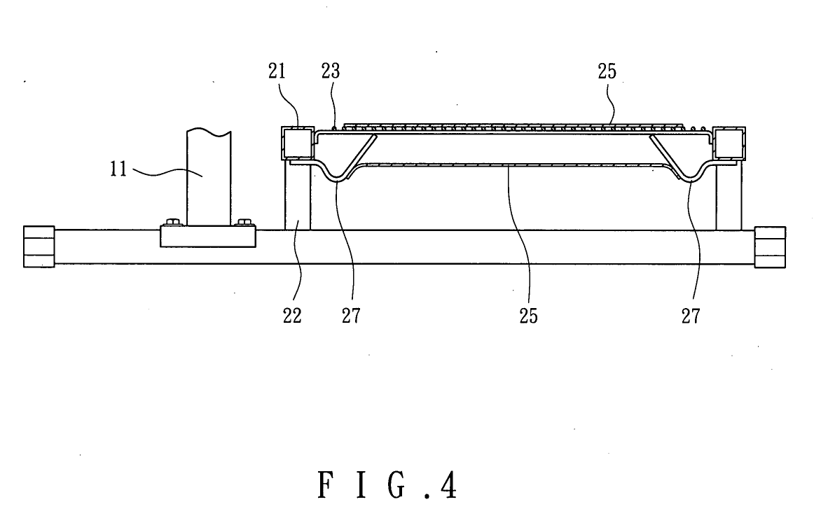

With reference to FIGS. 1 and 4, the exercise platform (20) is provided for the pet to jog thereon. The exercise platform (20) includes a longitudinal main frame (21) stably disposed on the supporting ground. Multiple supports (22) are secured on a bottom of the main frame (21) to make the main frame (22) being separated from the supporting ground. A support platform (23) is mounted within the main frame (21) for enhancing the structure of the main frame (21). Two driven axles (24) are transversely and rotatably mounted to two opposite ends of the main frame (21). An endless strap (25) is coiled the two driven axles (24) and surrounds the support (22). A shield (26) is mounted on one side of the main frame (21) for restricting the active area of the pet. Multiple limiters (27) are secured on two opposite sides of the bottom of the main frame (21) to prevent the endless strap (25) from detaching from the two driven axles (24). In the preferred embodiment of the present invention, the limiters (27) are bent rigid shaft for inward pushing the endless strap (25) for ensuring the endless strap (25) centrally corresponding to the main frame (21).

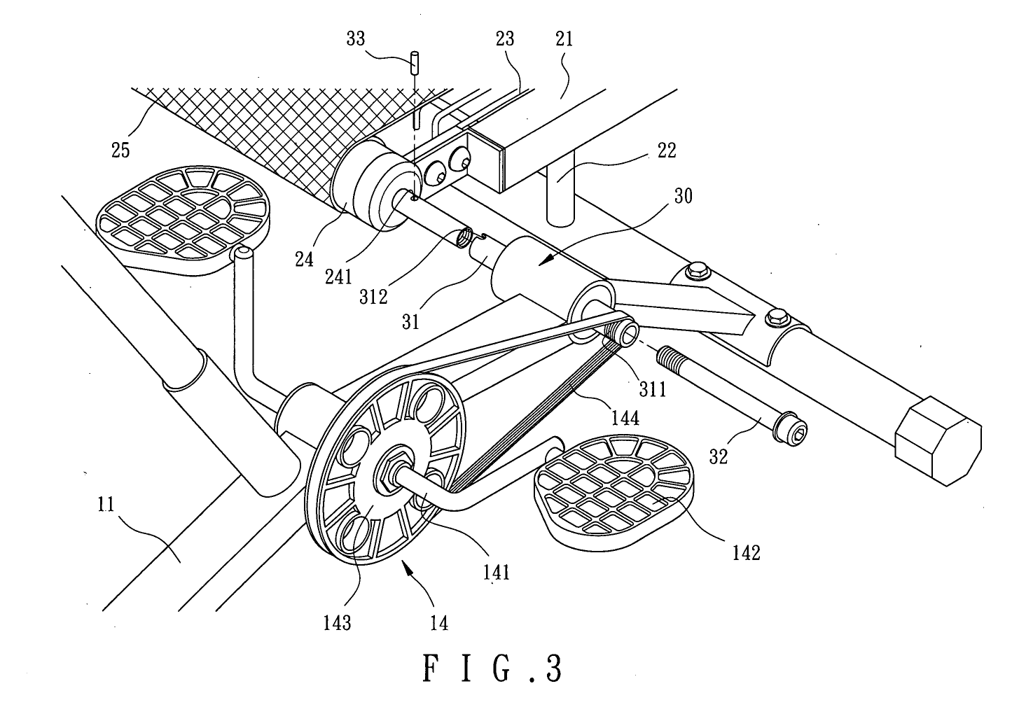

With reference to FIGS. 2 and 3, the link device (30) includes a hollow drive axle (31) having a first end co-axially connected to a corresponding one of the two driven axle (24) and a second end having multiple parallel grooves (311) defined therein. The first end of the drive axle (31) has an indentation (312) defined therein and the corresponding driven axle (24) has a bore (241) diametrically defined therein. A licking pin (33) extends through the bore in the corresponding driven axle (24) and engaged to the indentation (312) such that the drive axle (31) can not be axially rotated relative to the driven axle (24). In the preferred embodiment of the present invention, the drive element (144) is a belt that is coiled the drive wheel (143) and the second end of the drive axle (31), and engaged to the parallel grooves (311) in the second end of the drive axle (31). Consequently, the drive axle (31) is driven to drive the driven axle (24) when the step device (14) is operated. A fastener (32) longitudinally extends through the drive axle (31) and is co-axially mounted to the driven axle (24) such that the drive axle (31) can not be longitudinal moved relative to the driven axle (42). Accordingly, the step device (10) can be separated from the exercise platform (20) when the fastener (32) is detached from the driven axle (24) and the drive axle (31).

When operating the pet treadmill (100) in accordance with the present invention, the operator sits on the seat (12) and holds the handle bar (13), and the pet is called or pulled on the endless strap (25). Consequently, the pet imitates a jog action on the endless strap (25) when the operator/feeder step the pedals (142) to make the drive axle (31) drive the driven axle (24) with the endless strap (25).

The power source (10) of the present invention is manpower such that the moving speed of the endless strap (25) is controlled by the operator who sits on the seat (12) and watches the pet. Consequently, the operator can stop the treadmill anytime when the pet is tired or falls down. In addition, the structure of the support platform (23) is designed relative to the weight of the pet. In the preferred embodiment of the present invention, the support platform (23) has a net-like structure for reducing the manufacture cost of the pet treadmill (100) of the present invention.

Furthermore, the power source (10) can be selectively separated from the exercise platform (20) due to the link device (30) such that the total volume of the pet treadmill (100) in accordance with the present invention can be easily reduced for an easy storage and carry.

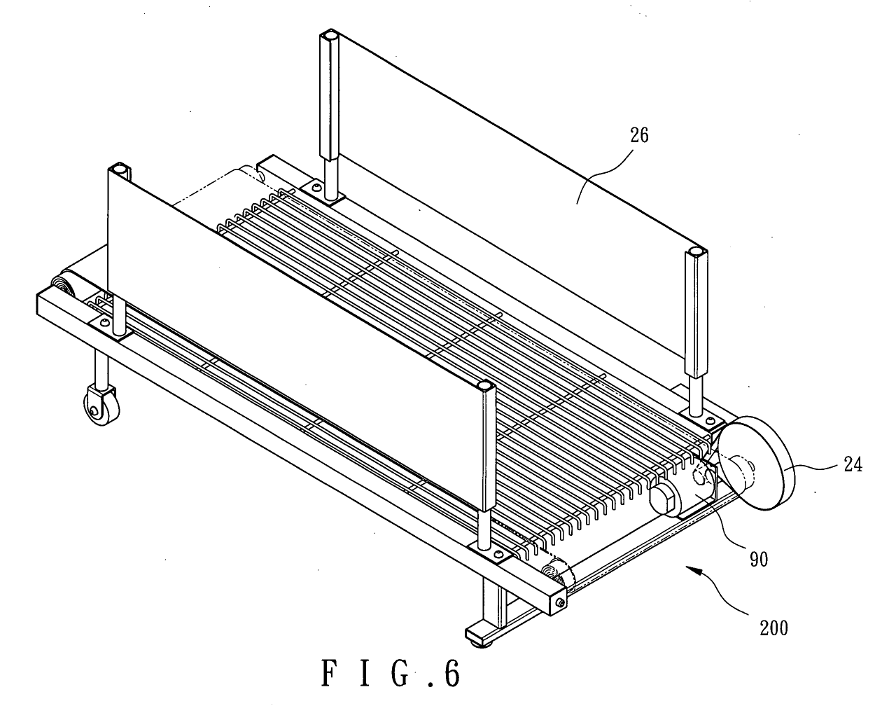

With reference to FIG. 6 that shows a second embodiment of the pet treadmill in accordance with the present invention, in this embodiment, the pet treadmill (200) includes motor (90) mounted on the exercise platform (20) for replacing the power source (10) of the first embodiment that is described above and driving the driven axle (24).

Although the invention has been explained in relation to its preferred embodiment, it is to be understood that many other possible modifications and variations can be made without departing from the spirit and scope of the invention as hereinafter claimed.

What is claimed is:

1. A pet treadmill comprising:
a manual power source for outputting a drive power; and
an exercise platform laterally connected to the manual power source, the exercise platform including a longitudinally main from stably disposed on a supporting ground, multiple supports secured on a bottom of the main frame to make the main frame being separated from the supporting ground, a support platform mounted within the main frame for enhancing the structure of the main frame, two driven axles transversely and rotatably mounted to two opposite ends of the main frame, an endless strap coiled the two driven axle and surround the support, wherein a corresponding one of the two driven axle is driven by the manual power source to operate the endless strap, on which the pet imitates a jog action.

2. The pet treadmill as claimed in claim 1, wherein the manual power source includes a base disposed on the supporting ground, a T-shaped hand bar and a step device respectively mounted on the base, the step device outputting drive power when the step device is operated.

3. The pet treadmill as claimed in claim 2, wherein the step device includes a crank mounted on and rotatable relative to the base, two pedals respectively mounted to two opposite ends of the crank for user to step thereon and drive the crank, a drive wheel securely sleeved on a horizontal portion of the crank such that the drive wheel synchronously rotated with the crank, a drive element linking the drive wheel and the corresponding driven axle such that the driven axle is rotated when the drive wheel is operated.

4. The pet treadmill as claimed in claim 3, wherein the drive element is a belt that partially surrounds the drive wheel and the corresponding driven axle.

5. The pet treadmill as claimed in claim 1, wherein the support platform has a net-like structure.

6. The pet treadmill as claimed in claim 1 further comprising a shield mounted on one side of the main frame for restricting the active area of the pet.

7. The pet treadmill as claimed in claim 1 further comprising multiple limiters secured on two opposite sides of the bottom of the main frame to prevent the endless strap from detaching from the two driven axles.

8. The pet treadmill as claimed in claim 7, wherein each limiter is bent rigid shaft for inward pushing the endless strap for ensuring the endless strap centrally corresponding to the main frame.

9. The pet treadmill as claimed in claim 1 further comprising a link device mounted between the manual power source and the exercise platform for transmitting the drive power from the manual power source to the exercise platform.

10. The pet treadmill as claimed in claim 9, wherein the link device includes a hollow drive axle having a first end co-axially connected to the corresponding driven axle, the first end of the drive axle having an indentation defined therein and the corresponding driven axle having a bore diametrically defined therein, a licking pin extending through the bore in the corresponding driven axle and engaged to the indentation such that the drive axle can not be axially rotated relative to the driven axle, a fastener longitudinally extending through the drive axle and co-axially mounted to the driven axle such that the drive axle can not be longitudinal moved relative to the driven axle.

11. A pet treadmill comprising:
a motor for outputting a drive power; and
an exercise platform laterally connected to the motor, the exercise platform including a longitudinally main from stably disposed on a supporting ground, multiple supports secured on a bottom of the main frame to make the main frame being separated from the supporting ground, a support platform mounted within the main frame for enhancing the structure of the main frame, two driven axles transversely and rotatably mounted to two opposite ends of the main frame, an endless strap coiled the two driven axle and surround the support, wherein a corresponding one of the two driven axle is driven by the motor to operate the endless strap, on which the pet imitates a jog action.

12. The pet treadmill as claimed in claim 11, wherein the support platform has a net-like structure.

13. The pet treadmill as claimed in claim 11 further comprising a shield mounted on one side of the main frame for restricting the active area of the pet.

14. The pet treadmill as claimed in claim 11 further comprising multiple limiters secured on two opposite sides of the bottom of the main frame to prevent the endless strap from detaching from the two driven axles.

15. The pet treadmill as claimed in claim 14, wherein each limiter is bent rigid shaft for inward pushing the endless strap for ensuring the endless strap centrally corresponding to the main frame.
